(19) United States
(12) Patent Application Publication
(10) Pub. No.: US 2003/0057718 A1
(43) Pub. Date: Mar. 27, 2003

(54) Striker plate for residential doors

(75) Inventor: Flek G. Stoehr, Massillon, OH (US)

Correspondence Address: Daniel A. Thomson, Emerson & Skeriotis, 14th Floor, One Cascade Plaza, Akron, OH, 44308-1147, US

(73) Assignee: F.G. Stoehr Builder, Massillon, OH

(21) Appl. No.: 10/256,966

(22) Filed: Sep. 26, 2002

Related U.S. Application Data
(60) Provisional application No. 60/325,230, filed on Sep. 27, 2001.

(51) Int. Cl. E05B 15/02

(52) U.S. Cl. 292/340

(57) ABSTRACT

A new and/or retrofitable striker plate with normal surfaces to accommodate fastening apertures, which are remote from the door jamb bolt opening and aligned with the jamb and jamb receiving support frame, respectively.

This application claims priority to a provisional patent application, entitled STRIKER PLATE FOR RESIDENTIAL DOORS, Serial No. 60/325,230, filed Sep. 27, 2001. This device relates to the field of strikers for jambs of door frames and more particularly to those for jambs of wooden door frames adapted to add door security.

### BACKGROUND OF THE INVENTION

1. Field of Invention

2. Description of the Related Art

Traditionally strikers are metal plates added to wooden jambs to provide a strike area for metal bolts with tapered ends to engage sockets in the jamb where the tapered portion of the bolt strikes the plate to retract the bolt for entry into the socket once the bolt is aligned with the socket; the bolt being biased to enter the socket upon alignment therewith. These plates have openings in them to provide access to the socket in the jamb and fastener apertures above and below the opening to permit attachment of the plate to the jamb on either side of the socket.

The need for door security has increased significantly especially in high-density population areas, i.e. condos, apartments, housing. The jamb is the weakest link with any residence's wood door system, not the door itself. My striker plate bends around the framing member and wood jamb to enhance the impenetrability of the door by preventing splitting of the lock side of the wood jamb and results in the dislocation of the striker plate and keeper during forced/thrust against the door. Also 3-inch, number 8 screws smartly penetrate the framing members at opposite angles to add strength. It is known to curve the approach edge of the striker plate to further accommodate the tapered portion of the closure bolt and even to add a plate to the door with a mirror shape to that of the striker plate to discourage sliding shims between the door and the striker plate which will move the tapered portion of the bolt in an unauthorized manner. Recently striker plates have been made with lips overlapping the edge of the jamb to also discourage passing shims between the plate and the jamb to engage the tapered portion of the bolt.

More recently, U-shaped strikers have appeared in the development of the shaped strikers which are built directly into the frame work of the dwelling in which the door is to be hung and alternately, for new door construction, the new door has a similarly shaped plate for reinforcing the traditional striker plate, but requires installation on the door jamb before it can be placed within the door opening.

### SUMMARY OF THE INVENTION

A striker plate of the present invention is adaptable to retrofit to existing jambs, which are in place on door openings in existing buildings as well as new jambs going into new construction. The striker plate has the advantage of a greater surface area over the traditional planar surface of the plate, which is the surface adjacent the portion of the door holding the locking bolt. In addition the striker plate has a second planar surface in the form of a leg extending behind the door frame molding, both of which substantially strengthen the retaining function of the striker plate, against forced entry of the door it is securing.

My invention is low cost and can be simply and readily installed without special tools or training, often only requiring a drill and screwdriver. Most residential doors open inwardly. My invention gives greater strength to the wood jamb. The jamb is reinforced, especially if the jamb is already split or slightly compromised. My invention provides the strength and advantages of a steel door jamb.

The striker plate of the present invention, in one embodiment, has rounded corners. The rounded corners help prevent accidental cuts from the corners. The corners can be any shape, however, as long as chosen using sound engineering judgment.

In one aspect the present invention provides a striker plate for application at one side of a wooden door jamb adjacent to a door bolt socket of a door frame. It includes a first planar surface having at least one bolt receiving opening and at least one fastener aperture adjacent the opening. The fastening aperture is substantially off set from the opening in the direction away from the engaging edge of the door jamb. A second planar surface has at least another fastener aperture oriented generally normal to the first planar surface to form a corner covering the engaging edge of the door jamb. Another fastener normal to the aperture is offset from the engaging edge of the door jamb at least a distance beyond the door jamb to align this aperture with support framing receiving the door frame.

In accordance with another aspect of the present invention, a striker plate has a face plate, a leg, the leg connected to an edge of the face plate, the leg extending substantially perpendicular to the face plate, at least one bolt receiving means, the receiving means being located on the face plate, at least one fastener receiving means located on the face plate, at least one fastener receiving means located on the leg, and a centerline, the centerline being drawn vertically through the face plate and the at least one bolt receiving means, the at least one fastener receiving means on the face plate being substantially offset from the centerline.

In accordance with yet another aspect of the present invention, the striker plate includes a conjoining edge where the face plate and the leg connect, a first face plate outside corner, a second face plate outside corner, the face plate outside corners being opposite the conjoining edge, the at least one fastener receiving means on the face plate being near the first face plate outside corner, a first leg outside corner, a second leg outside corner, the leg outside corners being opposite the conjoining edge, and at least a second fastener receiving means located near the second face plate outside corner.

In accordance with another aspect of the present invention, the striker plate includes a second centerline, the second centerline being drawn horizontally, the at least one fastener receiving means on the leg is located substantially on the second centerline, opposite the conjoining edge.

In accordance with another aspect of the present invention, the face plate has a width and the leg has a width, the width of the leg being greater than the width of the face plate.

In accordance with another aspect of the present invention, the at least one bolt receiving means is located substantially in the center of the face plate.

In accordance with another aspect of the present invention, the face plate has a length and the leg has a length, the lengths being greater than the widths, the conjoining edge having a length substantially similar to the face plate and the leg lengths.

In accordance with another aspect of the present invention, the striker plate comprises at least two bolt receiving means.

In accordance with another aspect of the present invention, the striker plate is metallic.

In accordance with another aspect of the present invention, a security device for use with an associated door frame, the door frame having a jamb and a support frame includes a first substantially planar surface having at least one bolt receiving means and at least one fastener receiving means, a second substantially planar surface having at least one fastener receiving means, a conjoining edge, the conjoining edge being the connection of the first and second substantially planar surfaces, the planar surfaces forming an approximate L-shape, and a centerline, the centerline being drawn vertically through the first substantially planar surface, the at least one fastener receiving means on the first substantially planar surface being offset from the centerline, opposite the conjoining edge.

In accordance with another aspect of the present invention, the security device further includes a first outside corner, a second outside corner, the first and second outside corners being opposite the conjoining edge, located on the first substantially planar surface, the at least one fastener receiving means on the first substantially planar surface being near the first outside corner, a third outside corner, a fourth outside corner, the third and fourth outside corners being opposite the conjoining edge, located on the second substantially planar surface, and at least a second fastener receiving means located near the second outside corner.

In accordance with another aspect of the present invention, the security device further includes a second centerline, the second centerline being drawn horizontally, the at least one fastener receiving means on the second substantially planar surface is located substantially on the second centerline, opposite the conjoining edge.

In accordance with another aspect of the present invention, the first substantially planar surface has a width and the second substantially planar surface has a width, the width of the second substantially planar surface being greater than the width of the first substantially planar surface.

In accordance with another aspect of the present invention, the at least one bolt receiving means is located substantially in the center of the face plate.

In accordance with another aspect of the present invention, the striker plate comprises at least two bolt receiving means.

In accordance with another aspect of the present invention, a method of securing an associated door includes the steps of providing a face plate, a leg, the leg connected to an edge of the face plate, the leg extending substantially perpendicular to the face plate, providing at least one bolt receiving means, the receiving means being located on the face plate, providing at least one fastener receiving means located on the face plate, providing at least one fastener receiving means located on the leg, the at least one fastener receiving means on the face plate being substantially offset from a vertical centerline, placing the face plate against an associated door jamb and the leg against an associated support member, inserting a fastener through the at least one fastener receiving means located on the face plate, thereby attaching the face plate to the door jamb, and inserting a fastener through the at least one fastener receiving means located on the leg, thereby attaching the leg to the support member.

In accordance with another aspect of the present invention, the fasteners are of a length to engage both the door jamb and the support member.

In accordance with another aspect of the present invention, the method further includes providing a second bolt receiving means located on the face plate.

In accordance with another aspect of the present invention, the method further includes providing a conjoining edge where the face plate and the leg connect, providing at least two fastener receiving means, the fastener receiving means being located in opposite corners, opposite the conjoining edge, and inserting a fastener through the second fastener receiving means.

Still other benefits and advantages of the invention will become apparent to those skilled in the art upon reading and understanding of the following detailed specification.

### BRIEF DESCRIPTION OF THE DRAWINGS

The above advantages will be readily evident upon study of the following specification and the accompanying drawings in which common reference numerals identify common elements wherein:

FIG. 1 is a perspective view of a prior art striker plate and locking bolt;

FIG. 2 is a perspective view of the plate of the present invention on a portion of its jamb and support frame structure;

FIG. 3 is a perspective view of the face and leg portion of the plate and jamb with the addition of door frame molding;

FIG. 4 is a perspective view of the striker plate with multiple bolt receiving means; and,

FIG. 5 is an end view of the striker plate showing the L-shape.

### DETAILED DESCRIPTION OF THE INVENTION

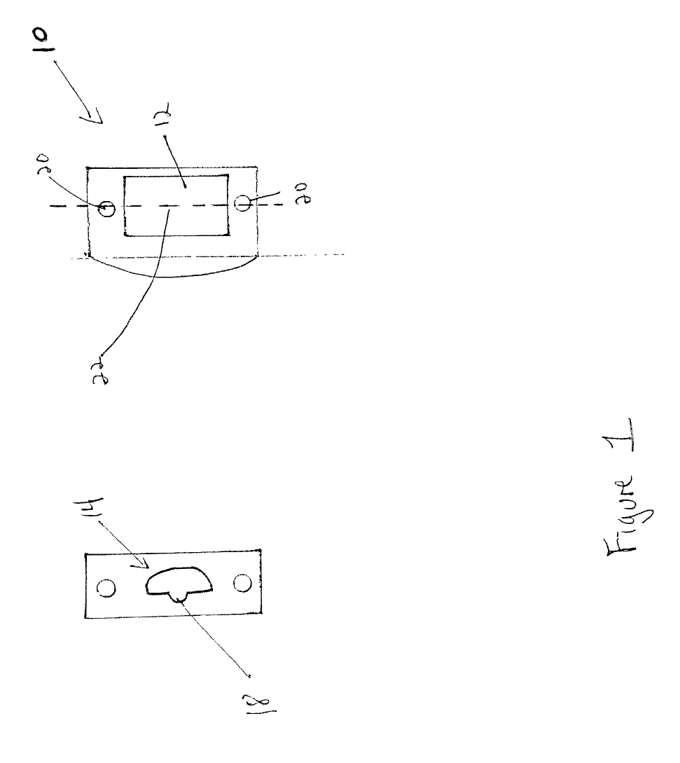

Referring now to the drawings wherein the showings are for purposes of illustrating at least one embodiment of the invention only and not for purposes of limiting the same, FIG. 1 shows a traditional striker plate 10 having an opening 12 for receiving a locking bolt 14 known in the prior art and functional with the handle of a door, not illustrated. The traditional locking bolt 14 may have a tapered surface for engaging the striker 10 and often times a securing member 18 operative independently of the bolt 14 to prevent the bolt 14 from being depressed whenever the securing member is depressed independently of the bolt 14.

The striker plate 10 can be seen to have two fasteners apertures 20 located above and below the opening 12 when the plate 10 is located in its position on a door jamb. A center line 22 of the fastener apertures 20 can be seen passed through the opening 12 placing the fastener apertures 20 adjacent the opening.

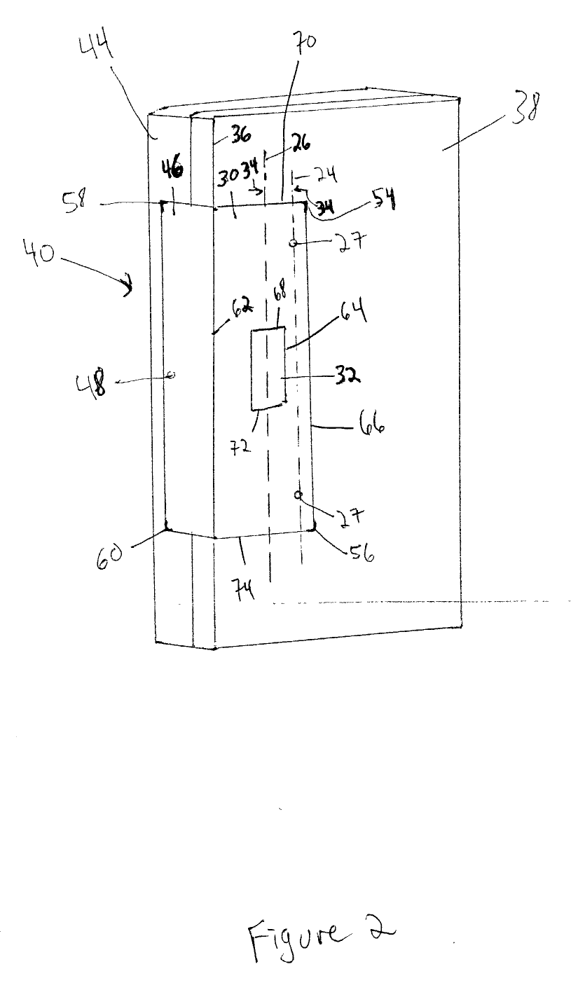

Most residential doors open inward where additional strength is needed against forced entry requiring a jamb as in FIG. 2. In FIG. 2 of the invention, a fastener centerline 24, which is associated with the present invention can be seen offset from a centerline 26 of a bolt receiving means 32, a substantial distance as illustrated between the arrows 34. This places fastener receiving means 27 further back from the edge 36 of a door jamb 38. This location of the receiving means 27 moves them from the location of the traditional striker plate 10 of FIG. 1, adjacent the opening 12 to a stronger, more secure position providing much more jamb 38 material. This new positioning of the fastening means 27 prevents shearing of the jamb 38 in the instance where the door (not shown) would be forced with bolt 14 within the bolt receiving means 32 of face plate 30 of striker plate 40 of the present invention.

With continuing reference to FIG. 2, the planar surface formed by the face plate 30 is enlarged over that of the traditional striker plate 10 to permit the location of the fastener receiving means 27 and additional material of the face plate 30 to add additional strength to that already obtained from the additional material in the jamb 38, which is that part swept by the door, itself. The face plate 30 extends a full width of the jamb 38 in this position and with the enlarged surface of the face plate 30 it is also possible to use larger fasteners 28, for example 3-inch long screws, which can even engage a support frame 44 in which the door frame is set, such as 2×4. Even further, the larger area of the face plate 30 accommodates larger fastener receiving means 27 for fasteners 28 such as the screws. It is to be understood that the invention is not limited to screws, but can use any fastening means chosen using sound engineering judgment.

As shown in FIG. 2, the face plate 30 has a first outside corner 54 and a second outside corner 56. The fastener receiving means 27 are located near the corners 54, 56. By near the corner 54 it is meant that the fastener receiving means 27 on the face plate 30 is located between an outside edge 66 of the face plate 30 and an outside edge 64 of the bolt receiving means 32, as well as being located between a top edge 68 of the bolt receiving means 32 and a top edge 70 of the face plate 30. By near the corner 56 it is meant that the fastener receiving means 27 on the face plate 30 is located between an outside edge 66 of the face plate 30 and an outside edge 64 of the bolt receiving means 32, as well as being located between a bottom edge 72 of the bolt receiving means 32 and a bottom edge 74 of the face plate 30.

With continuing reference to FIG. 2, the present invention has a second planar surface such as a leg 46, which is an extension of the face plate 30 generally normal to the plane of the face plate 30 in the form a leg 46. Leg 46 and face plate 30 form a conjoining edge 62, having a shape compatible with a bolt engaging edge 36 of the jamb 38. At least one fastener receiving means 48 is provided in the leg 46 to permit a screw 28, to pass through the receiving means 48 and engage the support member 44. By expanding the extended surface of the face plate 30 to the leg 46, additional surface area is provided for additional fasteners 28 as desired for engaging the support member 44 and multiple fastener receiving means 48 in the leg 46 can be provided to accommodate such fasteners.

The L-shaped striker plate 40 of this embodiment provides for enhanced strengthening of the door jamb 38 of both new and existing door jambs by enhanced location of fasteners 28, the increased surface area of the face plate 30 and leg 46 and the ability to permit fasteners 28 to engage the support member 44 of the door jamb 38. An example of a support member 44 is a 2×4, although it is to be understood that any support member, as long as chosen using sound engineering judgment, could be used.

The present invention may have a securing member 18 as shown in FIG. 1. The extended surface of face plate 30 accommodates assured operation of the securing member 18 by providing more metal in the location of the face plate 30. When engaged, the securing member 18 permits fine trimming of the bolt receiving means 32 where necessary for smooth independent operation of the bolt 14 and securing member 18.

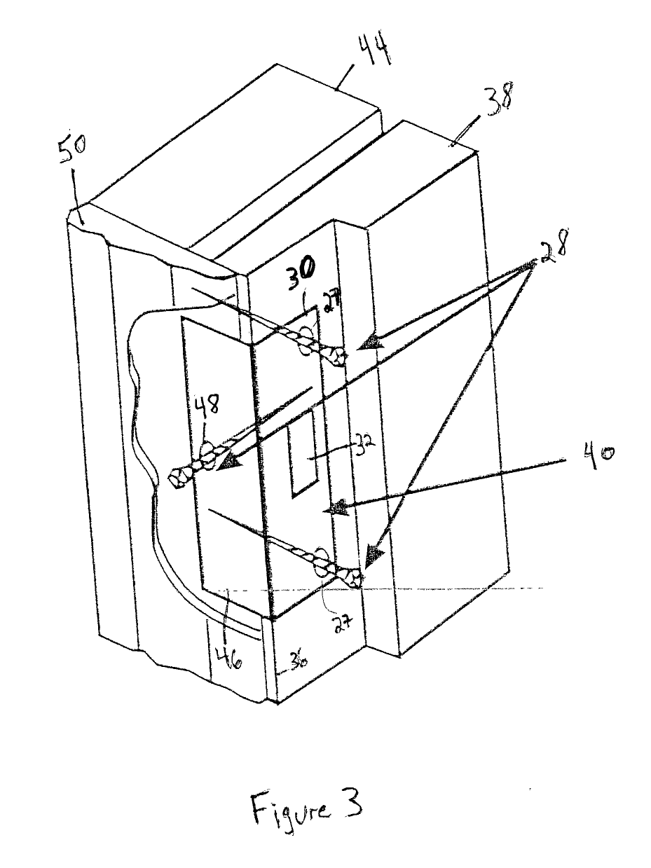

With reference now to FIG. 3, a portion of molding 50 is illustrated in its typical position in front of the door jamb 38 and has a molding aperture (not shown) therein which aligns with the fastener receiving means 48 of the leg 46 to permit the fastener 28, for engaging the support member 44, to be inserted without removing the molding 50 from the frame work of the jamb 38. It will be appreciated that the striker plate 40 of the present invention can be used as a retrofit to existing door jambs 38 by simply sliding the leg 46 behind the molding 50 and providing the aperture (not shown) to receive a fastener 28, which can be a decorative screw in this instance, and engages the leg 46 of the striker plate 40. Alternately, the molding 50 may be removed and multiple fastener apertures such as receiving means 48 may be provided for engagement with the support member 44. The same feature can be provided with new doors before the molding 50 is applied. In this embodiment, the screws 28 provide overlap each other and connect the door jamb 38 and support member 44.

The striker plate 40 of the present invention, in this embodiment, is a brass plate. Other material such as bronze, aluminum, stainless steel, etc can be used for the metal plate or even non-metallic materials of an equal or greater strength than the metallic materials can also be used.

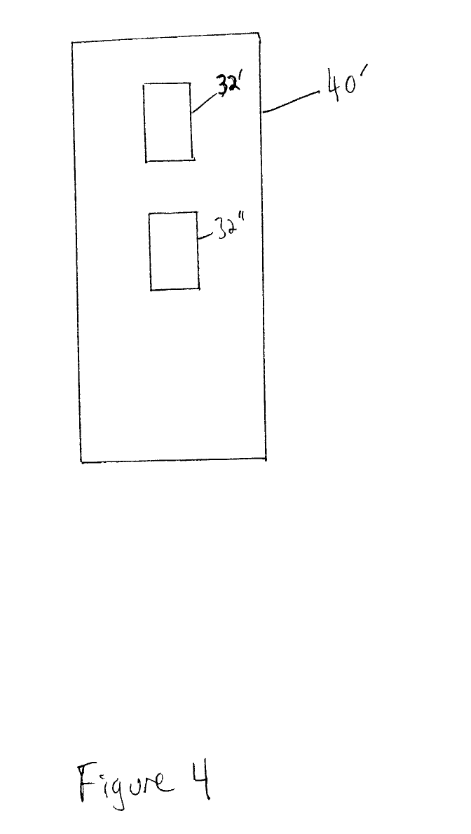

It is also contemplated that more than one striker plate could be used with a single door frame. For example, where both a door handle locking bolt and a dead bolt are provided, a striker plate 40 can be supplied for both bolts. Even further, it is anticipated, as shown in FIG. 4, that two such plates could be combined into one large plate 40′ for both bolts when the bolts are relatively close to one another. The two bolts would be received by bolt receiving means 32′, 32″.

Lastly, the present invention provides an economical solution to repair of damaged jambs 38, which due to the damage received in a forced entry, can no longer support a conventional striker plate 10, or alternatively have jambs 38 too weak to make use of the conventional plate 10 practical.

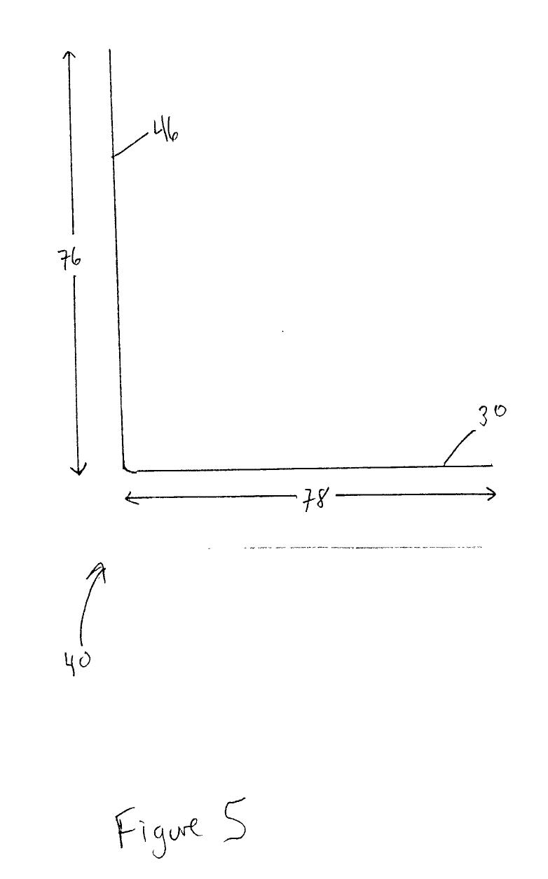

With reference now to FIG. 5, the striker plate 40 forms an approximate L-shape. The face plate 30 has a width 78 and the leg 46 has a width 76, wherein, in this embodiment, the leg width 76 is greater than the face plate width 78. In one embodiment, the leg 46 is 2 inches wide and 5 inches long, the face plate 30 is 1.75 inches wide and 5 inches long, the bolt receiving means 32 is 0.6875 inches wide and 1.25 inches in length, and is located 0.625 inches from the conjoining edge 62. In this embodiment, the face plate 30 and the leg 46 are between 0.03125 and 0.0625 inches thick. It is to be understood, however, that the above measurements are intended to describe an embodiment of this invention, and are not intended to limit it in any manner. Any dimensions, as long as chosen using sound engineering judgment, can be used.

The type of bolt that can be used or received by the present invention can be any type of bolt chosen using sound engineering judgment.

The invention has been described with reference to at least one embodiment. Obviously, modifications and alterations will occur to others upon a reading and understanding of this specification. It is intended to include all such modifications and alternations in so far as they come within the scope of the appended claims or the equivalence thereof.

Having thus described the invention, it is now claimed:

What is claimed is:

1. A striker plate comprising:
a face plate;
a leg, the leg connected to an edge of the face plate, the leg extending substantially perpendicular to the face plate;
at least one bolt receiving means, the receiving means being located on the face plate;
at least one fastener receiving means located on the face plate;
at least one fastener receiving means located on the leg; and,
a centerline, the centerline being drawn vertically through the face plate and the at least one bolt receiving means, the at least one fastener receiving means on the face plate being substantially offset from the centerline.

2. The striker plate of claim 1, wherein the striker plate further comprises:
a conjoining edge where the face plate and the leg connect;
a first face plate outside corner;
a second face plate outside corner, the face plate outside corners being opposite the conjoining edge, the at least one fastener receiving means on the face plate being near the first face plate outside corner;
a first leg outside corner;
a second leg outside corner, the leg outside corners being opposite the conjoining edge; and,
at least a second fastener receiving means located near the second face plate outside corner.

3. The striker plate of claim 2, wherein the striker plate further comprises:
a second centerline, the second centerline being drawn horizontally, the at least one fastener receiving means on the leg is located substantially on the second centerline, opposite the conjoining edge.

4. The striker plate of claim 3, wherein the face plate has a width and the leg has a width, the width of the leg being greater than the width of the face plate.

5. The striker plate of claim 4, wherein the at least one bolt receiving means is located substantially in the center of the face plate.

6. The striker plate of claim 5, wherein the face plate has a length and the leg has a length, the lengths being greater than the widths, the conjoining edge having a length substantially similar to the face plate and the leg lengths.

7. The striker plate of claim 6, wherein the striker plate comprises at least two bolt receiving means.

8. The striker plate of claim 7, wherein the striker plate is metallic.

9. A security device for use with an associated door frame, the door frame having a door jamb and a support frame, the security device comprising:
a first substantially planar surface having at least one bolt receiving means and at least one fastener receiving means;
a second substantially planar surface having at least one fastener receiving means;
a conjoining edge, the conjoining edge being the connection of the first and second substantially planar surfaces, the planar surfaces forming an approximate L-shape; and,
a centerline, the centerline being drawn vertically through the first substantially planar surface, the at least one fastener receiving means on the first substantially planar surface being offset from the centerline, opposite the conjoining edge.

10. The security device of claim 9, wherein the security device further comprises:
a first outside corner;
a second outside corner, the first and second outside corners being opposite the conjoining edge, located on the first substantially planar surface, the at least one fastener receiving means on the first substantially planar surface being near the first outside corner;
a third outside corner;
a fourth outside corner, the third and fourth outside corners being opposite the conjoining edge, located on the second substantially planar surface; and,
at least a second fastener receiving means located near the second outside corner.

11. The striker plate of claim 10, wherein the security device further comprises:
a second centerline, the second centerline being drawn horizontally, the at least one fastener receiving means on the second substantially planar surface is located substantially on the second centerline, opposite the conjoining edge.

12. The striker plate of claim 11, wherein the first substantially planar surface has a width and the second substantially planar surface has a width, the width of the second substantially planar surface being greater than the width of the first substantially planar surface.

13. The striker plate of claim 12, wherein the at least one bolt receiving means is located substantially in the center of the face plate.

14. The striker plate of claim 13, wherein the striker plate comprises at least two bolt receiving means.

15. A method of securing an associated door, the method comprising the steps of:
providing a face plate, a leg, the leg connected to an edge of the face plate, the leg extending substantially perpendicular to the face plate;
providing at least one bolt receiving means, the receiving means being located on the face plate;
providing at least one fastener receiving means located on the face plate;
providing at least one fastener receiving means located on the leg, the at least one fastener receiving means on the face plate being substantially offset from a vertical centerline;
placing the face plate against an associated door jamb and the leg against an associated support member;
inserting a fastener through the at least one fastener receiving means located on the face plate, thereby attaching the face plate to the door jamb; and,
inserting a fastener through the at least one fastener receiving means located on the leg, thereby attaching the leg to the support member.

16. The method of claim 15, wherein the fasteners are of a length to engage both the door jamb and the support member.

17. The method of claim 15, wherein the method further comprises the step of:
providing a second bolt receiving means located on the face plate.

18. The method of claim 15, wherein the method further comprises the step of:
providing a conjoining edge where the face plate and the leg connect;
providing at least two fastener receiving means, the fastener receiving means being located in opposite corners, opposite the conjoining edge; and,
inserting a fastener through the second fastener receiving means.
